(19) United States
(12) Patent Application Publication
(10) Pub. No.: US 2005/0213894 A1
(43) Pub. Date: Sep. 29, 2005

(54) OPTICAL FIBER CABLE ASSEMBLY

(76) Inventor: Daoning Su, Colchester (GB)

Correspondence Address: Daoning Su, 1 Sweet Briar Road, Stanway, Colchester, CO3 0HJ, GB

(21) Appl. No.: 10/907,195

(22) Filed: Mar. 24, 2005

(30) Foreign Application Priority Data
Mar. 27, 2004 (GB) 0406987.8

(51) Int. Cl. G02B 6/36

(52) U.S. Cl. 385/88

(57) ABSTRACT

An optical fiber cable assembly has opto-electronics components as integral part of the assembly.

The invention is related to an optical cable transmission medium having light source and receiver as integral part of the cable assembly.

### BACKGROUND

Optical fibers are widely used in communications, such as in long haul telecommunication, short distance LAN, and in professional and domestic equipment, e.g. HI-FI equipment.

The fibers in those applications are normally terminated with connectors of one kind or another. Those optical connectors are delicate and need to be free of dusts for reliability.

Multimode fibers used in LAN are always budgeted in its worst capability, i.e. over filled launch, to ensure that the fiber connection works at all the possible launch conditions. To a large degree those conditions are controlled by the interfacing between the optical fiber connectors.

It is also a trend that more and more equipments have optical input and output built-in, such as Hi-Fi units, computer sound card. However vast majority of users of those units are not going to use this high specification functionality. Therefore in most cases the advantage of incorporating the optical I/O function is not realised and the cost is not justified.

Electric cables are used for communication between different system components, e.g. a computer and peripherals. As technology advances, the speed of those cables becomes a bottleneck of the system performance. Electronic noise and attenuation are major issues of electric cables at high speed. Noise from other equipment is also a major concern for security systems, because electro-magnetically generated noise by electrical cables generates false alarm.

On another hand optical fiber cable can normally support higher speed and without electronic noise pickup. However with current standard fiber connectors, optical fiber cables are not as user friendly as electric cables.

### PREVIOUS SOLUTION

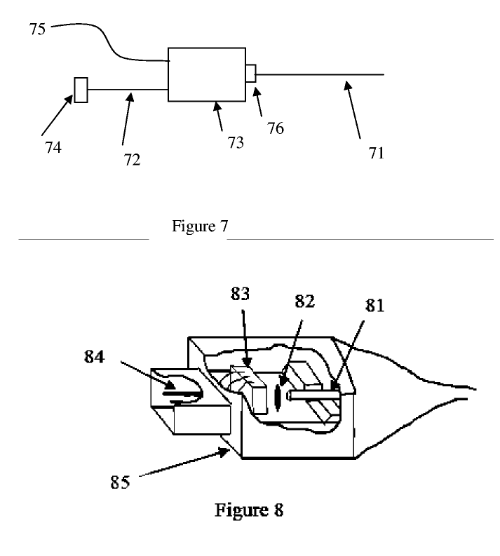

Previously optical cables, intended to replace a wired connection, consist of a conventional optical fiber cable (71), a wired cable (72) with electrical connector (74) and an electro-optical unit (73) for converting electrical signal to optical signal and optical signal to electrical signal, as shown in FIG. 7. Optical connector (76) connects the said optical cable (71) and the said electro-optical unit (73). A power supply (75) is usually utilised to power the said electro-optical unit (73). Although this type of solution serves the purpose, it is bulky and un-user friendly as mentioned before. Those cables are normally intended for extension of electric cables where distance exceeds electric cable capability.

### CURRENT INVENTION

It is the objective of this invention to create an optical fiber cable arrangement, which has the convenience of electric cable, advantages of optical fibers and overcomes the afore mentioned disadvantages. The current invention schematic is shown in FIG. 8, where micro-electro-optical components (83) are integrated within electrical connectors (85). Optical guide means (81) is disposed in between the said connectors and optically connected to the electro-optical components via optical assembly (82). Only one connector is shown in FIG. 8.

### ADVANTAGES OF THIS INVENTION

The cable is an integrated solution for electrical-optical-electrical communication. It offers advantages of an optical fiber, and has the compactness and user friendliness of an electrical cable. It is a user transparent electrical-optical-electrical solution. It provides the possibility of an optical drop-in replacement for traditional electrical cable, reduces the usage of optoelectronics component where it may never be used, provide the possibility of fixed integrated signal compensation circuit and significantly reduces EMI noise associated problems.

### DETAILED DESCRIPTION

According to this invention, an optical fiber cable with at least one optical fiber within is terminated with at least a light source and at least a light receiver. The light source converts electrical signal into optical signal. The said optical signal is coupled into the near end of the said optical fiber and propagates down stream to the distal end. A light receiver is located at the said distal end and receives the said signal. The said light receiver converts the optical signal into electric signal. The said optical cable is further terminated by electric connectors. The said connectors serve as interface between the light sources or light receiver and the electronic circuit external to the cable assemble. Although the said light source and said light receiver has different functionalities, they may be physically the same device and can be used for either or both of the functionalities.

The invention is further explained by way of, not limited to, embodiments.

According to the first embodiment, as shown in FIG. 1, the optical cable arrangement consists of an optical fiber (11), a transmitter end assembly consisting of a light source (13a), an optional coupling optics (12a) and an electric connector (14a), and a receiving end assembly consisting of a light receiver (13b), an optional coupling optics (12b) and an electrical connector (14b). The said electric connectors may be in the form of industry standard connectors. The light source and receiver may be integrated into the connector mechanical assembly. The light source 13a could be a LED or laser diode. The light receiver could be a photodiode.

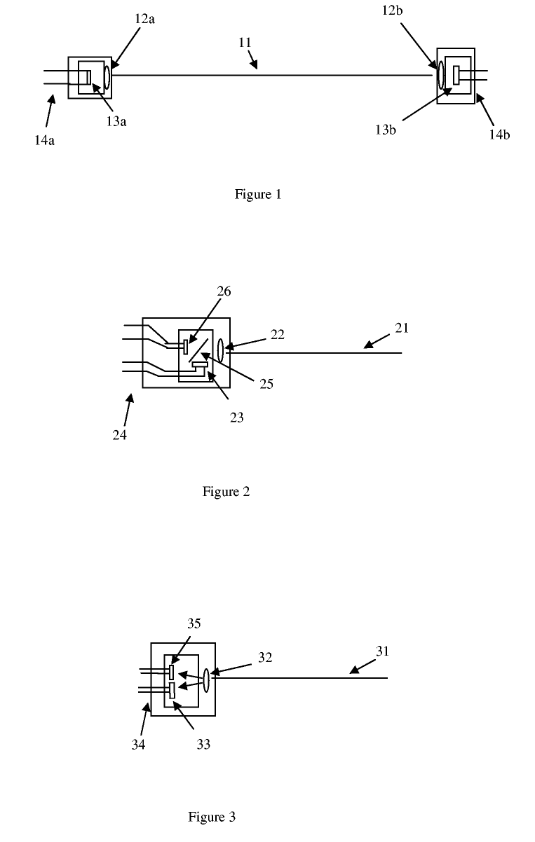

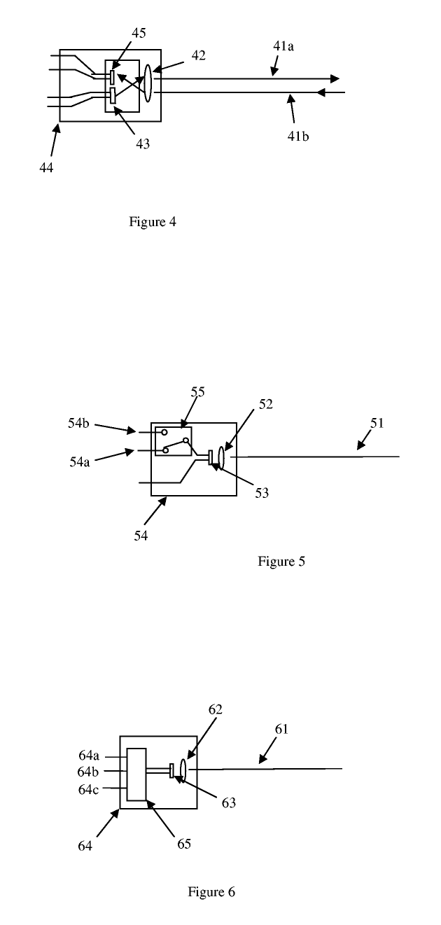

According to the second embodiment of this invention, as in FIG. 2, each end of the cable assembly consists of a optical guide (21), a light source (23), a light receiver (26), coupling optics (22), electrical connector (24) and light splitting/combining means (25). Only one end is shown in FIG. 2. The said light splitting/combining means (25) enables bi-directional communication. Within the spirit of this invention, other configurations are possible. Variant of this embodiment are shown in FIGS. 3 and 4. In FIG. 3, the electro-optical assembly consists of an optical guide (31), diffractive optics (32), light source (33), electrical connector (34) and light receiver (35). When in receiving mode as indicated by the light path in FIG. 3, the light is split and part of the light is incident on the light receiver. In FIG. 4 two optical guides (41a, 41b) are used. The said optical guide means (41a) guides the light from light source (43) to a light receiver (not shown) at distal end. The said optical guide means (41b) guides light from distal end to light receiver (45). Optical means (42) couples the said light guides (41a, 41b) to the said light source (43) and light receiver (45). Electrical connector means (44) connects the assembly to external electronic circuit (not shown).

According to the third embodiment, as shown schematically in FIG. 5, the electro-optical element (53), e.g. a LED or laser diode, is used for both light source and light receiver. A switching means (55) is utilised to switch the said electro-optical element (53) into transmitting or receiving mode. When light from light guide (51) is received by the said electro-optical element (53) via optical means (52), the said switching means (55) switches the electrical signal from the said electro-optical element (53) to the signal pin (54a) of electrical connector (54), the said electro-optical element (53) is said in receiving mode. When an electrical signal is applied onto electrical connecting pin (54b) of electrical connector (54), the said switching means connect pin (54b) to electro-optical element (53), the said electro-optical element (53) is said in transmitting mode. The said switching means can be a simple electronics switching circuit connected to external electronics via electric connector (54), or of self-initiating via signal detection means. The said switching means could be part of the fiber cable connector assembly or it could be external to the assembly and implemented in the electronics into which the said electric connector (54) is connected.

According to the fourth embodiment optical element (63) is the light source and light receiver. Connections (64a, 64b) of the electrical connector (64) are designated data lines. An electronics circuit (65) built into the connector assembly switches the said optical element (63) into different mode, transmitting or receiving, according to the signal from a control input (64c), as shown in FIG. 6. The said electronic circuit (65) may consist of switches and amplifiers and signal detection means to detect signal from optical guide (61) via optical element (62).

According to the fifth embodiment the said optical cable consists of multiple optical guide means, such as, but not limited to, a fiber ribbon cable. Each of the said optical guides has corresponding optical element (light source/receiver), e.g. laser arrays. Hence a multiple optical parallel links can be embodied in the same cable assembly.

According to the sixth embodiment, a metal conductor can be employed as part of the cable for non-critical functionalities such as control signal, power supply and strengthening.

The invention was explained by way of examples, however the spirit of this invention is not limited to the afore given embodiments. In particular the functionality of optics and electronics can vary depending on application. For example a dispersion correction circuit can be incorporated into the assembly. Because the launch condition for each fiber is fixed, the bandwidth of the fiber link can be tuned by a fixed compensation circuit.

1. An optical cable assembly consists of at least one optical guide means, at least one optical source and at least one optical sensitive element.

2. An optical cable assembly consists of at least one optical guide means, at least one electric conductor wire, at least one optical source and at least one optical sensitive element.

3. An optical cable assembly, as in claims 1 and 2, is terminated with at least one electric connector at at least one end of the assembly.

4. As in all the claims above the optical source is made of semiconductor material.

5. As in all the claims above the optical sensitive element is made of semiconductor material.

6. As in all the claims above the optical source is also a light sensitive element.

7. As in all the claims above, at least one electronics circuit is connected to at least one light source.

8. As in all the claims above, at least one electronics circuit is connected to at least one light sensitive element.

9. As in all the claims above, at least one electronics circuit is connected between the light sensitive element and the electric connector.

10. As in all the claims above, at least one electronics circuit is connected between the light source and the electric connector.

11. As in claims (7), (8), (9) and (10), the electronics circuit is a switching circuit.

12. As in claims (7), (8), (9) and (10), the electronics circuit is an amplification circuit.

13. As in claims (7), (8), (9) and (10), the electronics circuit is a signal compensation circuit.

14. As in claims (7), (8), (9) and (10), the electronics circuit is any combination of claims (11), (12) and (13).

15. As in all the claims above, an optical assembly is disposed in between the optical fiber and the light source.

16. As in all the claims above, an optical assembly is disposed in between the optical fiber and the light sensitive element.

17. As in claims (15) and (16), the optical assembly is coupling enhance optics consisting at least one optical element.

18. As in claims (15) and (16), the optical assembly is beam splitting optics consisting at least one optical element.

19. As in claims (15) and (16), at least one optical element is diffractive.

20. As in claims (15) and (16), at least one optical element is integral part of the optical guide means.
